(19) United States
(12) Patent Application Publication
(10) Pub. No.: US 2026/0131624 A1
(43) Pub. Date: May 14, 2026

(54) CONTROLLING AN AIR-CONDITIONING DEVICE USING ARTIFICIAL INTELLIGENCE

(71) Applicant: Siemens Mobility GmbH, München (DE)

(72) Inventors: Anne-Katrin Bartels, Essen (DE); Alexander Hildebrandt, Bochum (DE)

(21) Appl. No.: 19/116,530

(22) PCT Filed: Sep. 14, 2023
(86) PCT No.: PCT/EP2023/075253

§ 371 Date: Mar. 28, 2025

(30) Foreign Application Priority Data
Sep. 28, 2022 (DE) 10 2022 210 249.5

(51) Int. Cl. B60H 1/00; B61D 27/00

(52) U.S. Cl. CPC B60H 1/0073; B60H 1/00371; B60H 1/00742; B61D 27/0018

(57) ABSTRACT

A method for controlling an air-conditioning unit which air-conditions the interior of a vehicle includes using a control facility to control the air-conditioning unit in order to air-condition the interior of the vehicle. In order to improve the operation of the air-conditioning unit, a computing facility forms a model using an artificial neural network, the model being configured to ascertain a control variable to be output by the control facility using influencing variables which have an influence on the climate of the interior. A computer program which represents the model is used on the control facility in order to control the air-conditioning unit. An apparatus, a computer program, a computer-readable medium and a vehicle are also provided.

The invention relates to a method for controlling an air conditioning unit which air-conditions an interior of a vehicle. The air conditioning unit is controlled by a control facility in order to air-condition the interior of the vehicle using the control system. The invention further relates to an apparatus for controlling an air conditioning unit which air-conditions an interior of a vehicle. The apparatus comprises a control facility which is configured to control the air conditioning unit in order to air-condition the interior of the vehicle.

Air treatment in rail vehicles is described, for example, in the standards DIN EN 13129 (Title: Air conditioning for main line rolling stock-Comfort parameters and type tests), DIN EN 14750 (Title: Air conditioning for urban and suburban rolling stock) and DIN EN 14813 (Title: Air conditioning for driving cabs).

In principle, it is known to control an air conditioning unit with the aid of a controller. This controller is embodied, for example, as embedded software. Proportional-integral controllers or 2-point controllers are often used as controllers. Pre-control systems are also known for the controllers, and these react to input variables with a linear behavior, the parameters of which are set before the vehicle is operated.

Against this background, it is the object of the invention to improve the operation of the air conditioning unit.

This object is achieved by a method of the type mentioned in the introduction in which, with the aid of an artificial neural network, a computing facility forms a model which, using influencing variables which have an influence on the climate of the interior, is configured to ascertain a control variable for output by the control facility. A computer program representing the model is used on the control facility to control the air conditioning unit.

With the invention it was recognized that influencing variables which have an influence on the climate of the interior of the vehicle were not taken into account in previous controlling systems of the air conditioning unit or were only taken into account indirectly—by measuring a temperature deviation between the desired interior temperature and the actual interior temperature. The controlling system treats the entire system (consisting of vehicle, air conditioning unit and the vehicle's surroundings) as a black box and only reacts to a change in temperature within the interior. This results in inertia which is accompanied by a long duration until the desired temperature within the interior is reached. In addition, strong influences and the associated reaction of the controller can result in an overshooting of the system, and this further reduces the comfort for individuals who are located within the interior.

In addition, with the invention it was recognized that previous pre-control systems only take into account those influencing variables which are known to those skilled in the art and are therefore taken into account when setting the parameters of the pre-control system. This parameter setting remains static throughout the operation of the vehicle.

The inventive solution remedies this problem by using the artificial neural network to form a model. This model generates the control variable for output by the control facility, taking into account a large number of influencing variables. In this way, not only can all known influencing variables be taken into account, but previously unknown influencing variables can also be appropriately taken into account by training of the neural network (recognized as relevant influencing variables, so to speak). In addition, it is possible to optimize the behavior during operation of the vehicle.

The advantage of using an artificial neural network is that the influence of influencing variables is weighted in training. In addition, this influence can be analyzed by looking at the weightings resulting from training (the nodes of the network) in order to gain extensive knowledge for future operation of the air conditioning unit.

A further significant advantage which results from the use of an artificial neural network is that different influencing variables are linked when determining the control variable during processing by the neural network. This link enables the generation of route profiles which depend on various parameters, for example operating parameters of the vehicle. The route profiles can in turn be used to predict influencing variables: because if the vehicle is situated at a certain location on the route, it is possible to foresee which influencing factors are to be expected over the course of the route. This is further advantageous since the control system of the air conditioning unit can react to corresponding influences in a preparatory manner before they occur. This is particularly expedient for energy-optimized operation of the air conditioning unit.

The inventive method is preferably a computer-implemented method.

The air conditioning unit is intended, for example, to provide conditioned ambient air for an interior of the vehicle. The air conditioning unit is preferably controlled by controlling the heating and cooling output.

Preferably, the air conditioning unit is arranged on the roof of the vehicle, where it may be exposed to solar radiation during operation of the vehicle.

The control facility can be a central control facility. Alternatively or additionally, the control facility can be at least partially part of the air conditioning unit, for example be integrated in the air conditioning unit.

The vehicle is, for example, a land vehicle (for example an automobile), an aircraft (for example an airplane) or a watercraft (for example a ship).

The term “influencing variable” is often referred to as a “disturbance variable” by experts in the context of control engineering.

Preferably, the computer program is installed for use on the control facility (“deployment”) .

Preferably, the artificial neural network has one or more layer(s) of neurons which are not input neurons or output neurons. The layers of neurons which are not input neurons (input layer) or output neurons (output layer) are often referred to as hidden layers by experts. The hidden layers are preferably changed during training and learning of the artificial neural network. Machine learning, which concerns the artificial neural network with multiple hidden layers, is often referred to as deep learning by experts.

Further preferably, the artificial neural network is trained using training data, with the network being trained in a secured state in which an undesirable data-related attack is ruled out. The secured state is achieved, for example, by only using tested training data for training or by collecting training data during a commissioning and/or test phase that is protected from attackers.

Preferably, a plurality of influencing variables is linked together during processing of the influencing variables by the artificial neural network for ascertaining the control variable. Further preferably, a route profile is generated. The route profile is further preferably generated on the basis of the linking. The route profile further preferably depends on a plurality of parameters, for example on operating parameters of the vehicle. The route profile is further preferably used for predicting the influencing variables. If the vehicle is at a particular location on the route, it is possible to foresee which influencing variables are to be expected over the course of the route (and at which position over the course of the route). Further preferably, the control system of the air conditioning unit reacts to the influencing variables using the prediction before the corresponding influencing variables occur. This reaction preferably occurs during energy-optimized operation of the vehicle.

According to a preferred embodiment of the inventive method, the vehicle is a track-bound vehicle, preferably a rail vehicle. The interior of the track-bound vehicle comprises a passenger area for the stay of passengers.

For example, the track-bound vehicle is a high-speed long-distance public transport train or a regional train or a light rail, a tram or a subway for local public transport. The rail vehicle is, for example, a multiple unit.

The inventive method is particularly suitable for use with track-bound vehicles. This is because vehicles of this type have a large number of relevant influencing factors which can be relatively well detected and predicted due to the track guidance and the associated known route of the vehicle in advance.

According to a further preferred embodiment of the inventive method, the control facility comprises
a controller for generating the control variable and
a pre-control facility for influencing a manipulated variable provided for the controller,
   wherein the computer program, which represents the model, is used on the pre-control facility.

In this way, the behavior of the pre-control system of the controller can be determined by the computer program which represents the model. This is particularly expedient since previous pre-control systems take external influencing variables, such as outside temperature (outside the vehicle), solar radiation, etc. into account. However, the model can take further influencing variables into account and influence the manipulated variable of the controller accordingly. In addition, the behavior of the pre-control can be optimized during vehicle operation by taking the influencing factors into account.

In a preferred development, the computer program, which represents the model, is used on the pre-control facility and the controller.

In this way, the controlling system of the air conditioning unit can be replaced by the computer program which represents the model. The typical effects that occur with controllers, such as control deviation, can be avoided or at least reduced.

In a further preferred embodiment of the inventive method, the artificial neural network is trained using training data, wherein the training data is generated on the basis of past operation of the vehicle. In this way, past journeys and the data obtained from these journeys are used to increase the knowledge (through training) of the artificial neural network.

Alternatively or additionally, the artificial neural network is trained using training data, wherein the training data is generated on the basis of past operation of another vehicle of the same type. Since other vehicles of the same type in many aspects behave in the same way or analogously to the vehicle itself, further past journeys and the data obtained during these journeys can be used to increase the knowledge (through training) of the artificial neural network. The further vehicle of the same type is, for example, a further vehicle from the same vehicle fleet or a test vehicle.

Alternatively or additionally, the artificial neural network is trained using training data, wherein the training data is generated on the basis of a simulation of a system which represents the vehicle, the air conditioning unit and at least parts of the vehicle's surroundings. By simulating the system, the expected behavior of the system is ascertained and data which characterizes this behavior is obtained. This data can be used as training data to train the artificial neural network.

Alternatively or additionally, the artificial neural network is trained using training data, wherein the training data is generated on the basis of a development process in which the air conditioning unit is developed. The variant is based on the knowledge that data is already generated during the development of the air conditioning unit. For example, tests of the air conditioning unit are carried out during development, which generate data that can be used as a basis for training the artificial neural network.

According to a further preferred embodiment of the inventive method, the model is configured to ascertain an energy-optimized control variable for output by the control facility, wherein the energy-optimized control variable, when processed by the air conditioning unit, effects energy-optimized operation of the air conditioning unit. This embodiment is based on the knowledge that a conventional controller is only partially able to regulate the air conditioning unit in an energy-optimized manner. By contrast, the artificial neural network can be trained for energy-optimized operation, and output a corresponding control variable.

Further preferably, the energy-optimized control variable is a control variable which simultaneously (when processed by the air conditioning unit) effects a comfort-optimized operation of the air conditioning unit. In other words: both the energy consumption and the comfort of the passengers are taken into account by the artificial neural network or the artificial neural network is trained on both aspects.

The neural network is particularly suitable for energy-optimized operation of the air conditioning unit, for example, because it is possible to already react to influencing variables in a preparatory manner. For example, a route profile can be used for this purpose, for example the generated route profile described above, which enables the neural network to take into account foreseeable influencing variables-if they are to be expected over the course of the route. This can, for example, prevent energy-intensive, short-term alternations between heating and cooling.

According to a further preferred embodiment of the inventive method, the influencing variables comprise, as at least one influencing variable, a number of passengers who are located in the interior. The number of passengers is ascertained using a weight signal which is generated by a braking unit and/or a spring unit of the vehicle.

The weight signal is ascertained, for example, using the braking force and/or braking energy which the braking unit uses for a predefined braking process.

When the spring unit is embodied as an air spring, the weight signal may be ascertained, for example, using the air pressure within the air spring.

Alternatively or additionally, the number of passengers is ascertained by means of a passenger counting system. This variant is particularly advantageous when the vehicle is embodied as a track-bound vehicle, since passenger counting systems are often present anyway in track-bound vehicles and the passenger counting data from these passenger counting systems is already available.

Alternatively or additionally, the number of passengers is ascertained using the number of mobile terminals detected within the interior. This variant is based on the knowledge that the number of mobile terminals is a suitable measure as a basis for estimating the number of passengers located within the interior.

Preferably, the weight signal and the number of detected mobile devices can be linked by the neural network or parts of the neural network.

To ascertain the number of passengers located within the interior, the time of day can also be added in conjunction with the day of the week. This means that high passenger volumes, for example due to rush hour traffic, may be identified by the neural network.

According to a further preferred embodiment of the inventive method, the influencing variables comprise, as at least one influencing variable, solar radiation to which the vehicle is exposed during operation. The solar radiation is detected using a location signal and the resulting irradiation direction.

Preferably, a position of the vehicle is ascertained using the location signal. When the vehicle is embodied as a track-bound vehicle, a direction of travel of the vehicle is further preferably ascertained using the position and the route traveled. Using the current time (and the associated position of the sun), the irradiation direction of solar radiation is ascertained, further preferably taking the direction of travel into account.

Alternatively or additionally, the solar radiation is detected using the sun's shadow which is cast on the vehicle by an object in the surroundings of the vehicle. In other words: a reduction in solar radiation is ascertained using the sun's shadow. If the solar radiation (which would affect the vehicle without a shadow) and the sun's shadow are known, the solar radiation hitting the vehicle can be ascertained.

The object is, for example, a building, vegetation and/or a tunnel along the route traveled by the vehicle.

Alternatively or additionally, the solar radiation is ascertained using a point in time, preferably a time of year and time of day. This variant is based on the knowledge that the position of the sun and consequently the angle of incidence of the solar radiation depends on the time of day and the time of year.

Alternatively or additionally, the solar radiation is ascertained using weather data. Thus, for example, the presence of clouds can be taken into account when ascertaining the solar radiation.

When the vehicle is embodied as a track-bound vehicle, which is usually elongated, what is referred to as the sunny side of the vehicle, which is directly exposed to the solar radiation, may be particularly easily ascertained using the direction of irradiation.

According to a further preferred embodiment of the inventive method, the influencing variables comprise, as at least one influencing variable, an operating state of an electrical component of the vehicle, which is detected. This variant is based on the knowledge that electrical components radiate heat during their operation. This can be taken into account particularly easily by the artificial neural network using the operating state of the components. The operating state can include, for example, “ON” and “OFF”. An example of an electrical component is a lighting facility for illuminating the interior.

In a further preferred embodiment of the inventive method, the influencing variables comprise wind as at least one influencing variable. The wind is detected using a driving speed of the vehicle and/or using weather data. This embodiment is based on knowledge that wind has an influence on the heat supplied to the vehicle. The advantage here is that wind acting on the vehicle can be detected particularly easily using the driving speed of the vehicle and using weather data.

In a further preferred embodiment of the inventive method, the air conditioning unit is controlled using the control variable output by the control facility.

The invention further relates to a computer program comprising commands which, when the program is executed by a computing facility, cause it to carry out the method of the type described above. The invention further relates to a computer program product with a computer program of this type. The computing facility is preferably, at least in part, a computing facility of the track-bound vehicle and/or the land-based facility.

The invention further relates to a provision apparatus for the computer program of the type described above, wherein the provision apparatus stores and/or provides the computer program. The provision apparatus is, for example, a memory unit which stores and/or provides the computer program. Alternatively and/or additionally, the provision apparatus is, for example, a network service, a computer system, a server system, in particular a distributed, for example Cloud-based computer system and/or virtual computer system, which stores and/or provides the computer program product, preferably in the form of a data stream.

The computer program is provided in the form of a program data block as a file, in particular as a download file, or as a data stream, in particular as a download data stream, of the computer program. This provision can also be made, for example, as a partial download consisting of a plurality of parts. Such a computer program is read into a system using the provision apparatus, for example, so the inventive method is carried out on a computer.

The above-mentioned object is further achieved by an apparatus of the type mentioned in the introduction. The apparatus comprises a computing facility which, with the aid of an artificial neural network, is configured to form a model, wherein the model, using influencing variables which have an influence on the climate of the interior, is configured to ascertain a control variable for output by the control facility. The apparatus further comprises a computer program which represents the model and is configured to be used on the control facility for controlling the air conditioning unit.

The invention further relates to a vehicle, preferably a track-bound vehicle, with an apparatus of the type described above.

For advantages, embodiments and design details of the inventive computer program, the inventive provision apparatus, the inventive apparatus and the inventive vehicle, reference can be made to the above description of the corresponding method features of the inventive method.

Exemplary embodiments of the invention will be explained with reference to the drawings, in which:

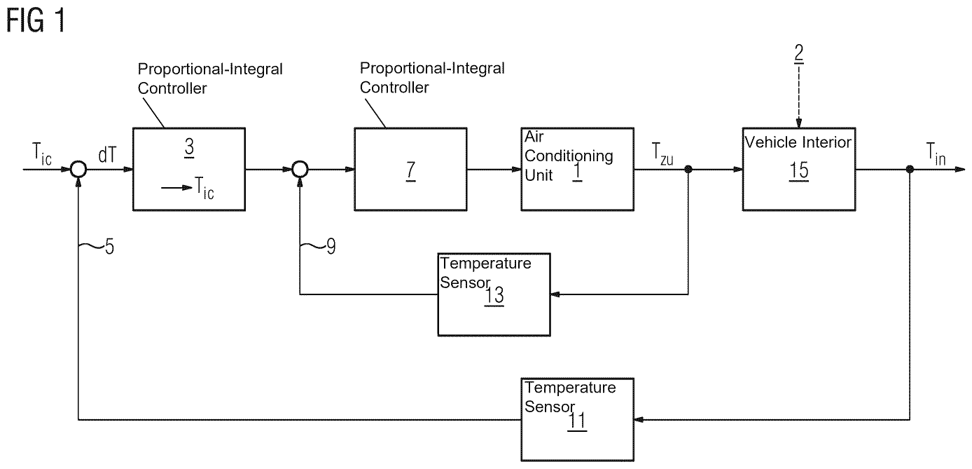

FIG. 1 schematically shows the structure of an example of a controlling system for an air conditioning unit,

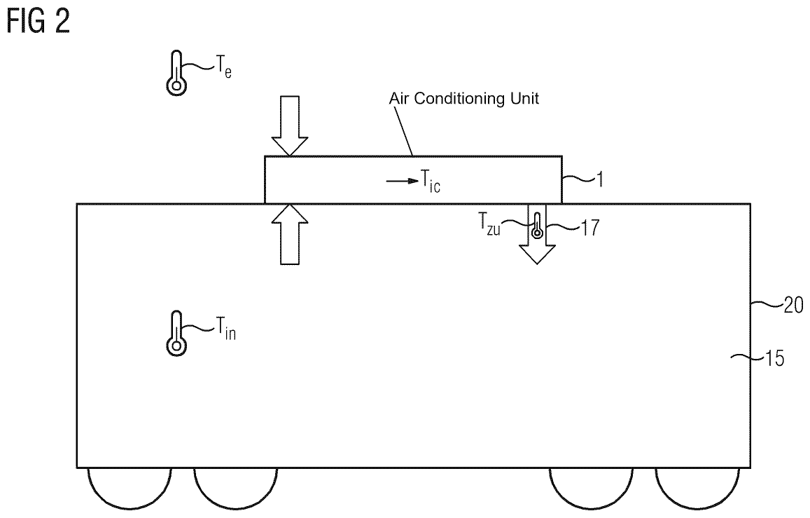

FIG. 2 schematically shows the structure of an example of a vehicle with an air conditioning unit,

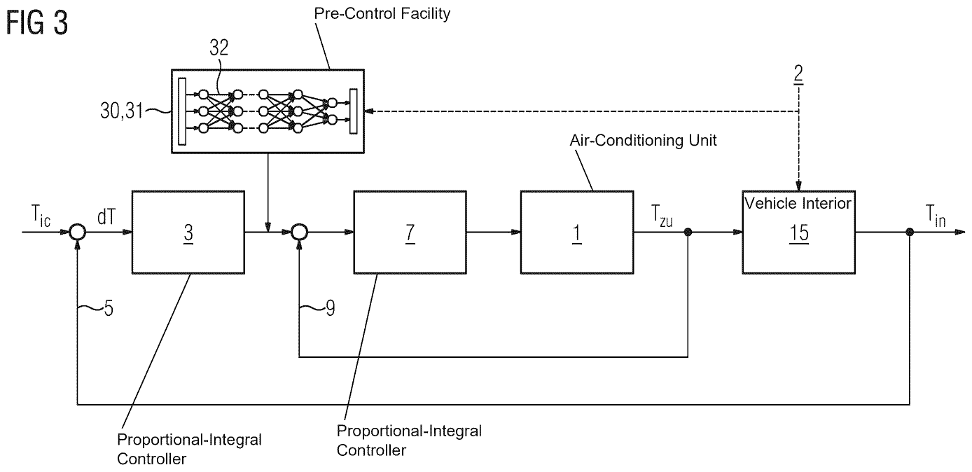

FIG. 3 schematically shows the structure of an exemplary embodiment of an inventive apparatus,

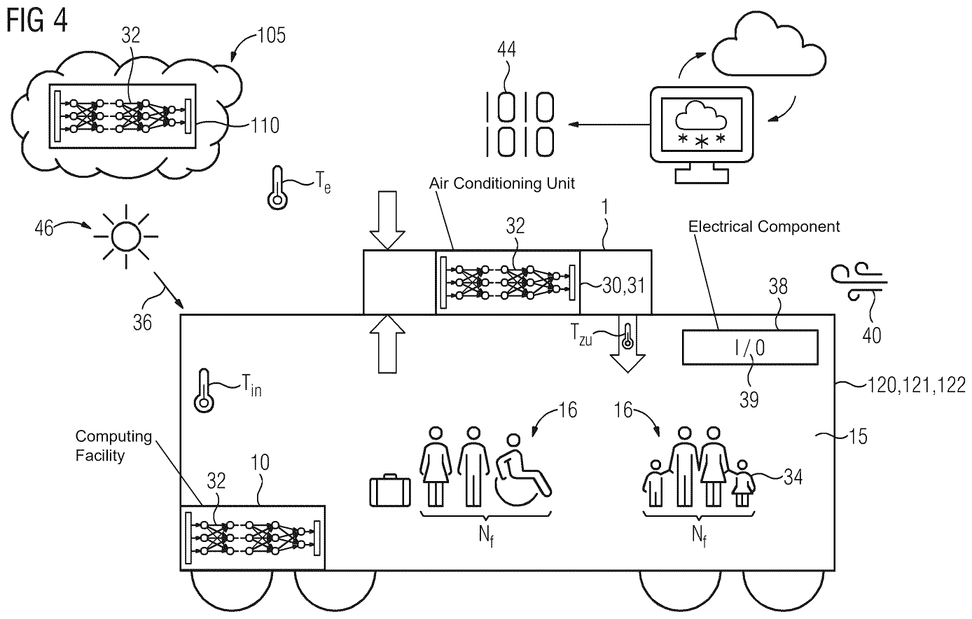

FIG. 4 schematically shows the structure of an exemplary embodiment of an inventive vehicle and

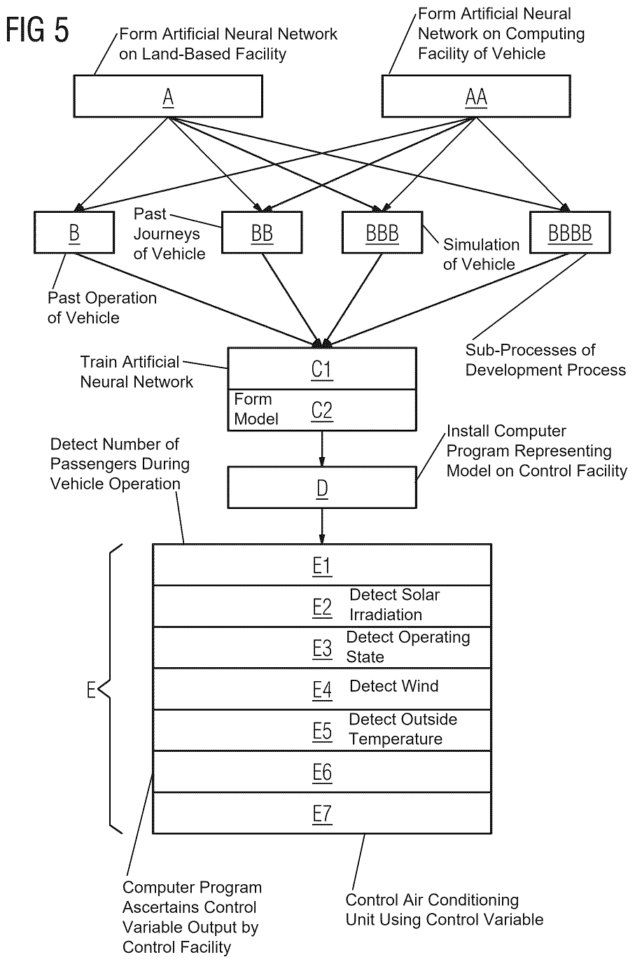

FIG. 5 schematically shows the sequence of an exemplary embodiment of an inventive method.

FIG. 1 schematically shows the structure of an example of a controlling system of an air conditioning unit 1. This controlling system comprises a proportional-integral controller 3 of an outer control loop 5 and a proportional-integral controller 7 of an inner control loop 9. The outer control loop 5 contains a temperature sensor 11 which measures a present room temperature Tᵢₙ within an interior of a vehicle 20 shown in FIG. 2. The inner control circuit 9 contains a temperature sensor 13, which measures a supply air temperature which is provided and supplied to the interior 15 of the vehicle by means of the air conditioning unit 1. The air conditioning unit 1 is regulated by regulating the heating and cooling output which the air conditioning unit 1 delivers to the supply air.

Any influencing variables 2 which have an influence on the climate of the interior 15 are not taken into account in this controlling system. Instead, the controlling system reacts to any deviations dT between the measured temperature Tᵢₙ and a desired setpoint interior temperature T_{ic} (what is referred to as the setpoint interior temperature).

FIG. 2 schematically shows the structure of an example of a vehicle 20. Outside the vehicle 20 there is an outside temperature Tₑ. The air conditioning unit 1 is arranged on the roof of the vehicle 20 and has the purpose of air conditioning the interior 15 of the vehicle 20. For this, the air conditioning unit supplies the interior 15 with supply air 17 with a supply air temperature T_{zu}. The supply air 17 effects an interior temperature Tᵢₙ within the interior 15. The aim of the air conditioning is to achieve the setpoint interior temperature T_{ic} within the interior 15.

FIG. 3 schematically shows the structure of an exemplary embodiment of the inventive apparatus. Identical or functionally identical elements are provided with the same reference numbers as in relation to FIG. 1. The apparatus comprises a proportional-integral controller 3 of an outer control loop 5 and a proportional-integral controller 7 of an inner control loop 9. A control facility 30 is provided in the effective direction between the outer controller 3 and the inner controller 7 and serves as a pre-control facility 31 to pre-control the controller 7. A computer program is used on the control facility 30 to control the air conditioning unit 1. The computer program represents a model which is formed by an artificial neural network 32.

FIG. 4 schematically shows the structure of an exemplary embodiment of an inventive apparatus and an inventive vehicle 120. Identical and functionally identical elements of the vehicle 120 are provided with the same reference numbers as in relation to the corresponding elements of the vehicle 20 according to FIG. 2.

The vehicle 120 is a track-bound vehicle 121, for example a rail vehicle 122. The interior 15 of the track-bound vehicle 121 comprises a passenger area 16 for the stay of passengers 34.

In a method step A, the artificial neural network 32 is generated or formed on a land-based facility 105 by means of a computing facility 110. Alternatively, the artificial neural network 32 is formed in a method step AA by means of a computing facility 10 as part of the control facility 30 of the vehicle 120.

The artificial neural network 32 has multiple layers of neurons which are not input neurons or output neurons. The artificial neural network 32 forms a model which, using influencing variables 2 which have an influence on the climate of the interior 15, is intended to be capable of ascertaining a control variable for output by the control facility 30.

One of the influencing variables 2 is, for example, the outside temperature Tₑ. A further influencing variable 2 is, for example, the number N_{f} of passengers 34 who are located within the interior 15 during operation of the air conditioning unit 1. Further, another influencing variable 2 is, for example, the solar radiation 36 to which the vehicle 120 is exposed during operation. A further influencing variable 2 is, for example, an operating state 39 of an electrical component 38 of the vehicle 120. A further influencing variable 2 is, for example, wind 40, which is detected using a driving speed of the vehicle and/or using weather data.

In a method step C1, the artificial neural network 32 is trained using training data. For example, the network is trained in a secured state in which an undesirable data-related attack is ruled out. The secured state is achieved, for example, by only using tested training data for training.

The training data is generated, for example, on the basis of past operation of the vehicle 120 in a method step B. For this purpose, influencing variables 2, associated output control variables of a pre-control facility and the resulting interior temperature Tᵢₙ are measured, for example, during previous journeys of the vehicle 120. These variables can also be measured during past journeys of a further vehicle of the same type in a method step BB. In addition, a simulation of a system which represents the vehicle 120, the air conditioning unit 1 and parts of the surroundings 46 of the vehicle 120 can be a basis for the generation of training data in a method step BBB. Furthermore, sub-processes of the development process in which the air conditioning unit 1 is developed, for example a test phase, can be the basis for the generation of training data in a method step BBBB.

After training the artificial neural network 32, a model is formed with the aid of the artificial neural network 32 (process step C2), which is configured to ascertain a control variable for output by the control facility 30 using the influencing variables 2.

The computer program which represents the model is installed on the control facility 30 in a method step D and is used in the further method, in particular during operation of the vehicle 120, according to a method step E.

The influencing variable N_{f} (number of passengers) is detected during operation of the vehicle 120 in a method step E1, for example using a weight signal which is generated by a brake unit or a spring unit of the vehicle 120, by means of a passenger counting system of the vehicle 120 and/or using the number of mobile terminals detected within the interior 15.

In addition, the influencing variable 36 (solar irradiation) is ascertained in a method step E2 by means of a location signal and a resulting irradiation direction, using the sun's shadow which is cast on the vehicle 120 by an object located in the surroundings of the vehicle, using a point in time, preferably a time of year and time of day, and/or ascertained using weather data 44.

Furthermore, the influencing variable 39 (operating state) is detected in a method step E3. For this purpose it is ascertained, for example, whether the electrical component 38 of the vehicle 120 is switched on or not.

In addition, the influencing variable 40 (wind) is detected in a method step E4 using a driving speed of the vehicle 120 and/or using weather data 44.

In addition, the outside temperature Tₑ is detected in a method step E5 by means of a temperature sensor and/or using weather data 44.

Using the above-mentioned and, if necessary, using further detected influencing variables, the computer program used on the control facility 30 ascertains in a method step E6 the control variable which is output by the control facility 30. In a method step E7, the air conditioning unit 1 is controlled using the control variable.

Although the invention has been illustrated and described in detail by the preferred exemplary embodiment, it is not limited by the disclosed examples and a person skilled in the art can derive other variations herefrom without departing from the scope of the invention.

1-15. (canceled)

16. A method for controlling an air conditioning unit for air-conditioning an interior of a vehicle, the method comprising:
using a control facility to control the air conditioning unit to air-condition the interior of the vehicle;
using a computing facility, aided by an artificial neural network, to form a model configured to ascertain a control variable to be output by the control facility, using influencing variables having an influence on a climate of the interior; and
using a computer program representing the model on the control facility to control the air conditioning unit.

17. The method according to claim 16, which further comprises providing a track-bound or rail vehicle as the vehicle, and providing a passenger area to be occupied by passengers in the interior of the vehicle.

18. The method according to claim 16, which further comprises providing the control facility with:
a controller for generating the control variable;
a pre-control facility for influencing a manipulated variable provided for the controller; and
the computer program representing the model being used on the pre-control facility.

19. The method according to claim 18, which further comprises using the computer program representing the model on the pre-control facility and the controller.

20. The method according to claim 16, which further comprises:
training the artificial neural network by using training data; and
generating (B, BB, BBB, BBBB) the training data based on at least one of:
a past operation of the vehicle, or
a past operation of a further vehicle of the same type, or
a simulation of a system representing the vehicle, the air conditioning unit and at least parts of surroundings of the vehicle, or
a development process in which the air conditioning unit is developed.

21. The method according to claim 16, which further comprises configuring the model to ascertain an energy-optimized control variable for output by the control facility, the energy-optimized control variable, when processed by the air conditioning unit, carrying out an energy-optimized operation of the air conditioning unit.

22. The method according to claim 16, which further comprises:
providing at least one of the influencing variables as a number of passengers located within the interior; and
ascertaining the number of passengers by at least one of:
using a weight signal generated by a brake unit or a spring unit of the vehicle, or
using a passenger counting system, or
using a number of mobile terminals detected within the interior.

23. The method according to claim 16, which further comprises:
providing at least one of the influencing variables as solar radiation to which the vehicle is exposed during operation; and
ascertaining the solar radiation by at least one of:
using a location signal and a resulting irradiation direction, or
using the sun's shadow cast onto the vehicle by an object situated in the surroundings of the vehicle, or
using a point in time or a time of year and time of day, or
using weather data.

24. The method according to claim 16, which further comprises providing at least one of the influencing variables as a detected operating state of an electrical component of the vehicle.

25. The method according to claim 16, which further comprises:
providing at least one of the influencing variables as wind; and
detected the wind by at least one of:
using a driving speed of the vehicle, or
using weather data.

26. The method according to claim 16, which further comprises controlling the air conditioning unit by using the control variable output by the control facility.

27. A non-transitory computer program product, comprising commands which, when executing the program on a computing facility, cause the computing facility to carry out the method according to claim 16.

28. A non-transitory computer-readable medium for the computer program product according to claim 27, the computer-readable medium at least one of storing or providing the computer program.

29. An apparatus for controlling an air conditioning unit for air-conditioning an interior of a vehicle, the apparatus comprising:
a control facility configured to control the air conditioning unit to air-condition the interior of the vehicle;
a computing facility configured to form a model, aided by an artificial neural network, said model configured to ascertain a control variable to be output by said control facility using influencing variables having an influence on a climate of the interior; and
a computer program representing said model and being configured to be used on said control facility to control the air conditioning unit.

30. A vehicle or track-bound vehicle, comprising the apparatus according to claim 29.
